(19) United States
(12) Patent Application Publication
(10) Pub. No.: US 2024/0356648 A1
(43) Pub. Date: Oct. 24, 2024

(54) PAM-4 TRANSCEIVER FOR CAPACITIVE-DRIVEN CHANNELS CAPABLE OF CANCELING CROSSTALK AND OPERATION METHOD THEREOF

(71) Applicant: KOREA UNIVERSITY RESEARCH AND BUSINESS FOUNDATION, Seoul (KR)

(72) Inventors: Chulwoo KIM, Seoul (KR); Seongcheol KIM, Seoul (KR); Jincheol SIM, Seoul (KR); Youngwook KWON, Seoul (KR); Junseob SO, Seoul (KR)

(21) Appl. No.: 18/583,011

(22) Filed: Feb. 21, 2024

(30) Foreign Application Priority Data
Apr. 20, 2023 (KR) 10-2023-0052017

(51) Int. Cl. H04B 10/40; H04B 10/524

(52) U.S. Cl. CPC H04B 10/40; H04B 10/524

(57) ABSTRACT

Disclosed are a PAM-4 transceiver for capacitive-driven channels capable of canceling crosstalk and an operation method thereof. The PAM-4 transceiver includes a first channel that transmits and receives a PAM-4 signal generated based on a first input signal through a coupling capacitor disposed at a transmitting stage, and a second channel and a third channel disposed adjacent to the first channel, and the first channel includes a converter that receives a second input signal of the second channel and a third input signal of the third channel, and a cancellation circuit connected to the converter and that cancels a crosstalk occurring in the first channel due to the second input signal and the third input signal, and the cancellation circuit outputs a compensation signal corresponding to the crosstalk based on the second input signal and the third input signal.

### CROSS-REFERENCE TO RELATED APPLICATIONS

This application claims priority under 35 U.S.C. § 119 to Korean Patent Application No. 10-2023-0052017 filed on Apr. 20, 2023, in the Korean Intellectual Property Office, the disclosures of which are incorporated by reference herein in their entireties.

### BACKGROUND

Embodiments of the present disclosure described herein relate to a PAM-4 transceiver, and more particularly, relate to a PAM-4 transceiver for capacitive-driven channels capable of canceling crosstalk and an operation method thereof.

As the amount of data transmission increases, a demand for transceivers with short lengths and large parallel channels is increasing.

In response to this demand, a capacitive-driven channel method that connects a coupling capacitor to an output stage is being utilized to increase signal bandwidth and reduce power consumption.

In addition, beyond the NRZ (Non-Return-to-Zero) modulation method that uses two levels of 0 and 1, a PAM-4 (Pulse Amplitude Modulation-4) modulation method that uses four levels of 00, 01, 10, and 11 is attracting attention.

When the PAM-4 modulation method is used, 2-bit signals may be transmitted and received in one UI (Unit Interval), so it has an advantage of being able to transmit and receive twice as much data as the NRZ modulation method at the same frequency. However, in addition to this, the voltage margin becomes smaller, and there are problems in that it becomes difficult to guarantee signal integrity against various noises, interference between channels, signal reflection, etc.

In particular, as the channel density increases, interference between signals may occur due to components coupled between adjacent channels. In addition, when the channel length is short, interference between signals may occur due to capacitive coupling.

### SUMMARY

Embodiments of the present disclosure provide a PAM-4 transceiver for capacitive-driven channels by placing a coupling capacitor at a transmitting stage.

Embodiments of the present disclosure provide a PAM-4 transceiver capable of canceling crosstalk caused by signals of adjacent channels by implementing a cancellation circuit that outputs a compensation signal with respect to crosstalk.

According to an embodiment of the present disclosure, a PAM-4 transceiver includes a first channel that transmits and receives a PAM-4 signal generated based on a first input signal through a coupling capacitor disposed at a transmitting stage, and a second channel and a third channel disposed adjacent to the first channel, and the first channel includes a converter that receives a second input signal of the second channel and a third input signal of the third channel, and a cancellation circuit connected to the converter and that cancels a crosstalk occurring in the first channel due to the second input signal and the third input signal, and the cancellation circuit outputs a compensation signal corresponding to the crosstalk based on the second input signal and the third input signal.

According to an embodiment, the converter may determine a component of the crosstalk occurring in the first channel based on the second input signal and the third input signal, and the cancellation circuit may output the compensation signal including an opposite component to the determined component of the crosstalk.

According to an embodiment, the cancellation circuit may include a plurality of transistors, and may output the compensation signal including the opposite component by activating at least some of the plurality of transistors based on the component of the crosstalk.

According to an embodiment, the first channel may include a driver that generates the PAM-4 signal having four signal levels from the first input signal, and may transmit a signal obtained by combining the compensation signal with the PAM-4 signal.

According to an embodiment, the driver may generate three bit outputs with preset weights based on an MSB input and an LSB input included in the first input signal, and may generate the PAM-4 signal having the four signal levels using the three bit outputs.

According to an embodiment, the first channel may further include a power source connected to the driver, and when a signal with a preset pattern occurs among the PAM-4 signal, the first channel may apply an input voltage to a path through which the PAM-4 signal is transmitted using the power source.

According to an embodiment, a receiving stage of the first channel may include a first comparator, a second comparator, and a decoder, the first comparator may compare a received signal received from the transmitting stage with a first reference voltage and output a first comparison result, the second comparator may compare the received signal with a second reference voltage and outputs a second comparison result, and the decoder may generate an LSB output based on whether the first comparison result is the same as the second comparison result.

According to an embodiment, the first comparison result may include a first voltage margin between the received signal and the first reference voltage, the second comparison result may include a second voltage margin between the received signal and the second reference voltage, and the decoder may generate an MSB output by comparing sizes of the first voltage margin and the second voltage margin.

According to an embodiment of the present disclosure, a transceiver includes a transmitting stage and a receiving stage connected through a high-density channel, and the transmitting stage includes a driver including a coupling capacitor and that generates a PAM-4 signal having 4 levels from a first input signal, and a cancellation circuit that receives a second input signal from at least one adjacent channel and outputs a compensation signal corresponding to a crosstalk occurring due to the second input signal, and the transmitting stage outputs a transmission signal obtained by combining the compensation signal with the PAM-4 signal, and the receiving stage includes a first comparator, a second comparator, and a decoder connected to the first comparator and the second comparator, compares the transmission signal with a first reference voltage and a second reference voltage using the first comparator and the second comparator, and generates an output signal corresponding to the first input signal through the decoder based on the comparison result.

According to an embodiment, the driver may generate three bit outputs based on an MSB input and an LSB input, which are included in the first input signal, and may generate the PAM-4 signal with the 4 levels using the three bit outputs.

According to an embodiment, the cancellation circuit may determine a component of the crosstalk based on the second input signal, and may output the compensation signal including an opposite component of the component of the crosstalk.

According to an embodiment, the decoder may generate an LSB output based on whether a first comparison result of the first comparator is the same as a second comparison result of the second comparator, and may generate an MSB output by comparing a size of a first voltage margin included in the first comparison result with a size of a second voltage margin included in the second comparison result.

### BRIEF DESCRIPTION OF THE FIGURES

The above and other objects and features of the present disclosure will become apparent by describing in detail embodiments thereof with reference to the accompanying drawings.

FIG. 1 is a circuit diagram of a PAM-4 transceiver according to an embodiment of the present disclosure.

FIG. 2A illustrates an example of a driver of FIG. 1.

FIG. 2B illustrates an example of a conversion circuit of FIG. 1.

FIG. 2C illustrates a table including data input to a conversion circuit of FIG. 2B and data output from a conversion circuit of FIG. 2B.

FIG. 2D illustrates a PAM-4 signal generated by a driver of FIG. 2A.

FIG. 3A illustrates a power source connected to a transmitting stage according to the present disclosure.

FIG. 3B illustrates a PAM-4 signal when a power source of FIG. 3A is input.

FIG. 4A illustrates a transmitting stage including a cancellation circuit of FIG. 1.

FIG. 4B illustrates a table including an output of a cancellation circuit according to inputs of the second and third channels.

FIG. 4C illustrates an example of a circuit diagram of a cancellation circuit of FIG. 1.

FIG. 4D illustrates an example of a converter connected with a cancellation circuit according to the present disclosure.

FIG. 5A illustrates a receiving stage including a first comparator, a second comparator, and a decoder according to the present disclosure.

FIG. 5B illustrates a PAM-4 signal and a reference voltage according to the present disclosure.

FIG. 5C illustrates logic by which a decoder of FIG. 5A determines an LSB output based on a comparison result of a first comparator and a second comparator.

FIG. 5D illustrates logic by which a decoder of FIG. 5A determines an MSB output based on a comparison result of a first comparator and a second comparator.

### DETAILED DESCRIPTION

Hereinafter, the present disclosure will be described with reference to the attached drawings. While various embodiments of the present disclosure are susceptible to various modifications and have several embodiments, specific embodiments thereof are illustrated by way of an example in the drawings and detailed descriptions thereof will be described. It should be understood, however, that there is no intent to limit the present disclosure to the particular forms disclosed, but on the contrary, the present disclosure is to cover all modifications and/or equivalents, and alternatives falling within the spirit and scope of the present disclosure. With regard to description of drawings, similar elements may be marked by similar reference numerals.

The expressions “include” and “comprise” or “may include” and “may comprise” used in embodiments of the present disclosure indicate existence of corresponding features, operations, or elements disclosed herein but do not exclude additional one or more functions, operations, or elements. Also, it will be further understood that the terms “comprises,” “comprising,” “includes,” and/or “including,” as used herein, specify the presence of stated features, numbers, steps, operations, elements, and/or components, but do not preclude the presence or addition of one or more other features, items, steps, operations, elements, components, and/or groups thereof.

In the present disclosure, expressions such as “or” include any and all combinations of words listed together. For example, the term “A or B” may refer to all of the case (1) where ‘A’ is included, the case (2) where ‘B’ is included, or the case (3) where both of ‘A’ and ‘B’ are included.

The expressions such as “first”, “second”, and the like used in the present disclosure may refer to various elements of the present disclosure, but do not limit the corresponding elements. For example, the terms may not limit order and/or priority of the elements. Such terms may be used to distinguish one element from another element. For example, “a first user device” and “a second user device” indicate different user devices. For example, a first component may be named as a second component, and vice versa, without departing from the scope of the present disclosure.

It will be understood that when an element is referred to as being “connected” or “coupled” to another element, it can be directly connected or coupled to the other element or intervening elements may be present. In contrast, when an element is referred to as being “directly connected” or “directly coupled” to another element, it should be understood that there are no intervening elements.

The terms used in present disclosure are only used to describe specific embodiments and are not intended to limit the present disclosure. Singular expressions may include plural expressions unless the context clearly dictates otherwise.

Unless otherwise defined, all terms (including technical and scientific terms) used herein have the same meaning as generally understood by those skilled in the art to which this present disclosure pertains. The terms, such as those defined in commonly used dictionaries, should be interpreted as having a meaning that is consistent with their meaning in the context of the relevant art and will not be interpreted in an idealized or overly formal sense unless expressly so defined herein.

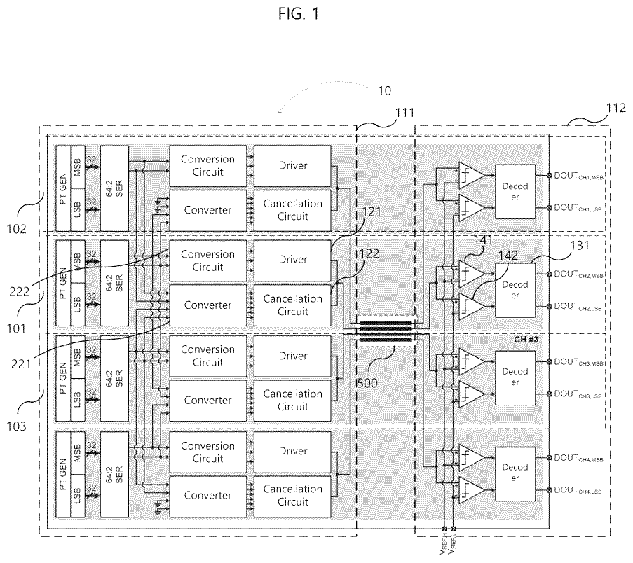

FIG. 1 is a circuit diagram of a PAM-4 transceiver according to an embodiment of the present disclosure.

Referring to FIG. 1, a PAM-4 transceiver 10 according to an embodiment may include a transmitting stage 111 and a receiving stage 112 that are connected through a high-density channel 500 and transmit and receive a PAM-4 (pulse amplitude modulation-4) signal.

According to an embodiment, the transmitting stage 111 may convert an input signal into the PAM-4 signal so as to be transmitted. In addition, the receiving stage 112 may decode the received PAM-4 signal and may output an output signal corresponding to the input signal.

In addition, the PAM-4 transceiver 10 may include a plurality of channels for transmitting and receiving PAM-4 signals.

In more detail, the PAM-4 transceiver 10 may include a first channel 101 including a configuration for transmitting and receiving the PAM-4 signal. In addition, the PAM-4 transceiver 10 may include a second channel 102 and a third channel 103 that have a configuration corresponding to the first channel 1010 and are disposed adjacent to the first channel 101.

In this case, the transmitting stage of each of a plurality of channels may include a driver that generates and transmits the PAM-4 signal from the input signal, and a cancellation circuit that generates a compensation signal to cancel crosstalk (or noise).

In addition, the receiving stage of each of the plurality of channels may include a comparator and a decoder that convert the received signal into an output signal corresponding to the input signal.

For example, the transmitting stage of the first channel 101 includes a driver 121 that generates the PAM-4 signal having 4 levels from the input signal and a cancellation circuit 122 that generates a compensation signal to cancel crosstalk. In addition, the receiving stage of the first channel 101 may include a first comparator 141, a second comparator 142, and a decoder 131 that convert the received PAM-4 signal to generate an output signal corresponding to the input signal.

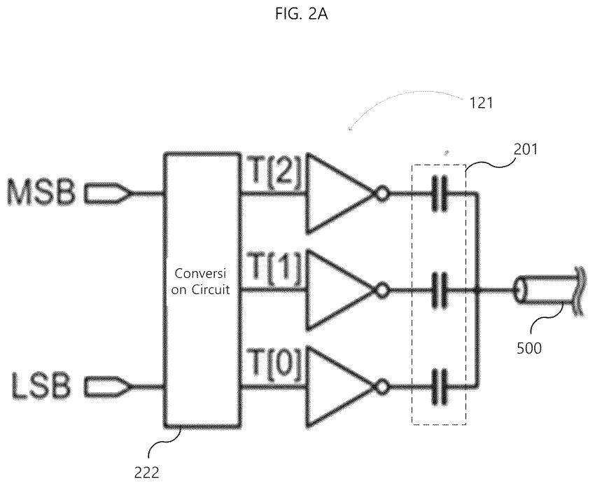

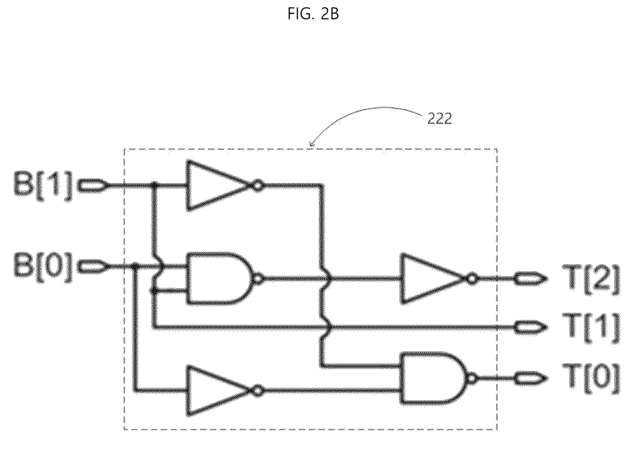

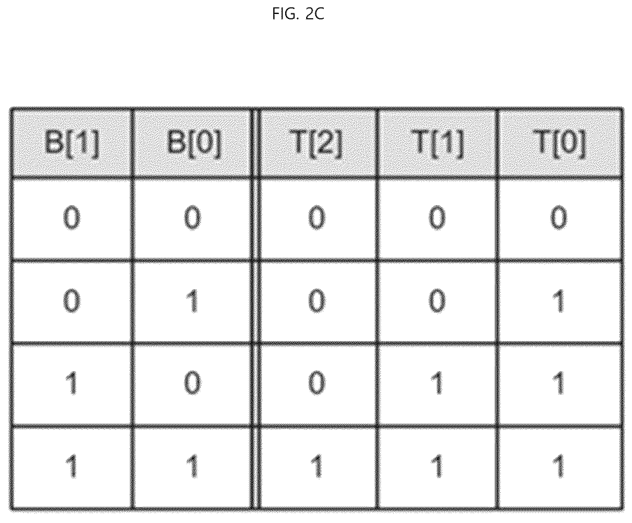

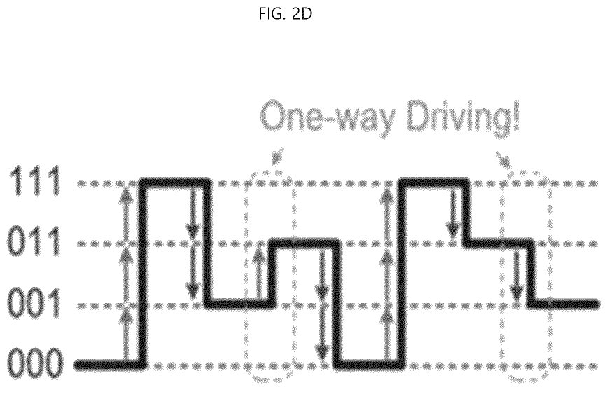

In addition, according to an embodiment, the transmitting stage 111 of each channel may include a coupling capacitor (e.g., a coupling capacitor 201 of FIG. 2A) disposed in a path through which the PAM-4 signal is transmitted.

In detail, as the transmitting stage 111 includes the coupling capacitor 201, the PAM-4 transceiver 10 according to the present disclosure may be referred to as a transceiver that transmits and receives the PAM-4 signal through the capacitive-driven channels.

As previously described, since the transmitting stage 111 transmits and receives the PAM-4 signal through the capacitive-driven channels including the coupling capacitor 201, the PAM-4 transceiver 10 according to the present disclosure may increase a bandwidth of the output signal.

In addition, the PAM-4 transceiver 10 according to the present disclosure may reduce power consumption required for transmitting and receiving signals by transmitting and receiving the PAM-4 signal through the capacitive-driven channels.

FIG. 2A illustrates an example of a driver of FIG. 1. FIG. 2B illustrates an example of a conversion circuit of FIG. 1. FIG. 2C illustrates a table including data input to a conversion circuit of FIG. 2B and data output from a conversion circuit of FIG. 2B. FIG. 2D illustrates a PAM-4 signal generated by a driver of FIG. 2A.

Referring to FIG. 2A, the driver 121 according to an embodiment may include a conversion circuit 222 that converts the input signal and the coupling capacitor 201 disposed in the path through which the converted signal is transmitted. The PAM-4 transceiver according to the present disclosure may transmit and receive the PAM-4 signal through the capacitive-driven channels.

However, the driver 121 is illustrated as being formed integrally with the conversion circuit 222, but is not limited thereto. Referring to FIG. 1 as another example, the conversion circuit 222 may be formed as a separate component and may be connected to the driver 121.

In addition, referring to FIG. 2B, the conversion circuit 222 may be formed of a plurality of logic gates. For example, the conversion circuit 222 may be formed of at least one NAND gate and at least one inverter, but a circuit configuration of the conversion circuit 222 is not limited to the above-described example.

Referring to FIGS. 1 and 2A to 2D together, the driver 121 according to an embodiment may be configured to generate the PAM-4 signal having 4 levels based on the signal received from the conversion circuit 222. In more detail, the driver 121 may generate the PAM-4 signal having four signal levels based on an MSB input and an LSB input provided to the conversion circuit 222.

To this end, first, the driver 121 may convert the MSB input and LSB input into three bits with the same weight (thermometer weight) using the conversion circuit 222. In this case, the MSB input and the LSB input may be referred to as having binary weight.

For example, the driver 121 may convert the MSB input and the LSB input into three bits each having a weight of “1” using the conversion circuit 222.

Referring to FIG. 2C, when the MSB input is “1” and the LSB input is “0”, the driver 121 may generate bits of “011” each having a weight of “1” with respect to the received input signals using the conversion circuit 222. However, the weight and number of bits of each input or output are not limited to the examples described above.

In this case, the conversion circuit 222 may be understood as a B2T converter (binary to thermometer converter) that converts the MSB input and LSB input with binary weight into a 3-bit signal with a thermometer weight.

Furthermore, the driver 121 may generate the PAM-4 signal having different 4 levels (e.g., 000, 001, 011, and 111) as illustrated in FIG. 2D using a 3-bit signal.

In detail, the driver 121 according to the present disclosure may generate the PAM-4 signal having four different signal levels using the 3-bit signal with the same weight.

Through the above-described configuration, the PAM-4 transceiver 10 according to the present disclosure may prevent signal interference caused by signals (or different edges) changing in different directions.

In addition, the PAM-4 transceiver 10 may reduce power consumption required for signal transmission and may improve the quality of the transmitted signal.

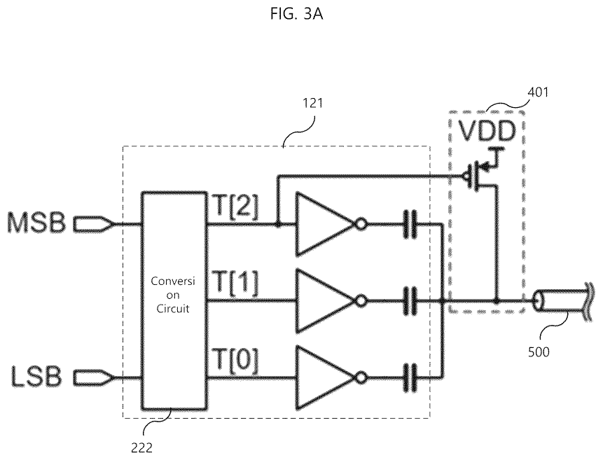

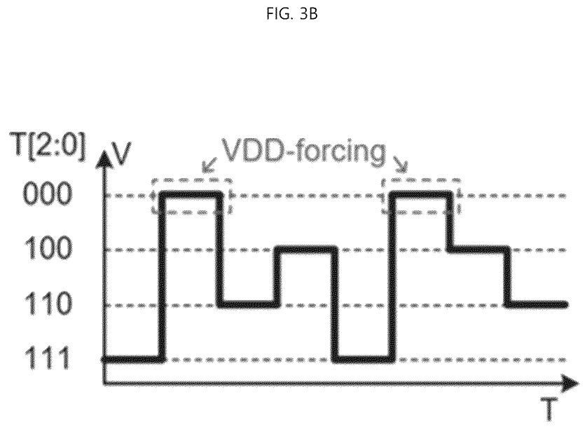

FIG. 3A illustrates a power source connected to a transmitting stage according to the present disclosure. FIG. 3B illustrates a PAM-4 signal when a power source of FIG. 3A is input.

Referring to FIG. 3A, the first channel 101 according to an embodiment may further include a power source 401 connected to the driver 121 (or the transmitting stage).

In more detail, the first channel 101 may further include the power source 401 that is connected to a path through which the PAM-4 signal output from the driver 121 is transmitted and applies a voltage. In this case, the power source 401 may be referred to as a direct current (DC) power source.

According to an embodiment, the PAM-4 transceiver 10 may apply a voltage (e.g., VDD) to a transmission path of the PAM-4 signal using the power source 401 when a signal with a preset pattern is generated among the PAM-4 signal.

For example, when the PAM-4 signal is generated as a bit of “000”, the PAM-4 transceiver 10 may activate (or turn on) the transistor connected to the power source 401. Alternatively, when the PAM-4 signal has the highest level, the PAM-4 transceiver 10 may activate (or turn on) the transistor connected to the power source 401.

Through this, the PAM-4 transceiver 10 may apply a voltage to the transmission path of the PAM-4 signal using the power source 401.

In detail, the PAM-4 transceiver 10 may force a bias voltage on the transmitted signal according to a certain probability of occurrence of a preset pattern.

Through the above-described configuration, the PAM-4 transceiver 10 according to an embodiment of the present disclosure may prevent errors that may occur at the receiving stage due to floating of the transmission and reception channels.

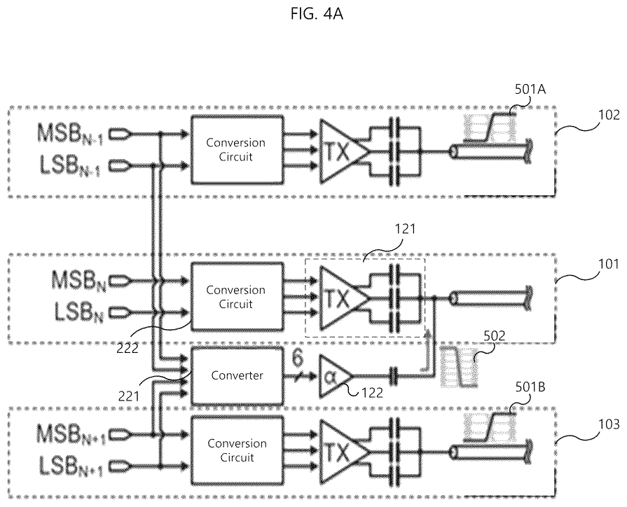

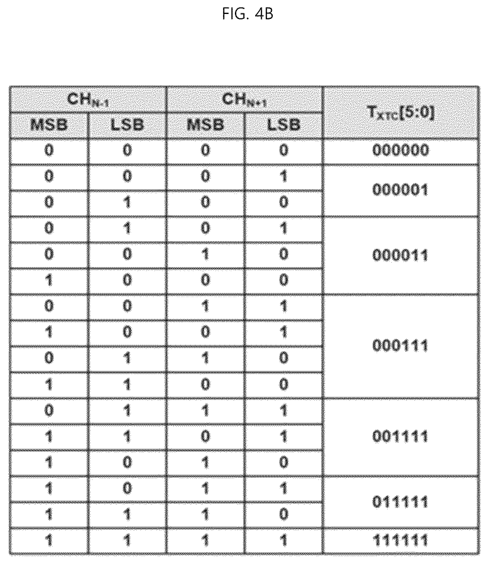

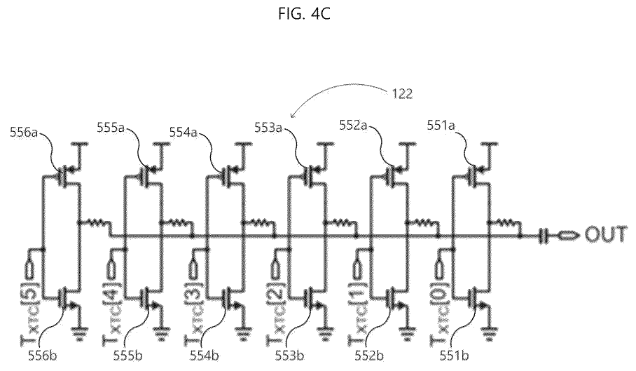

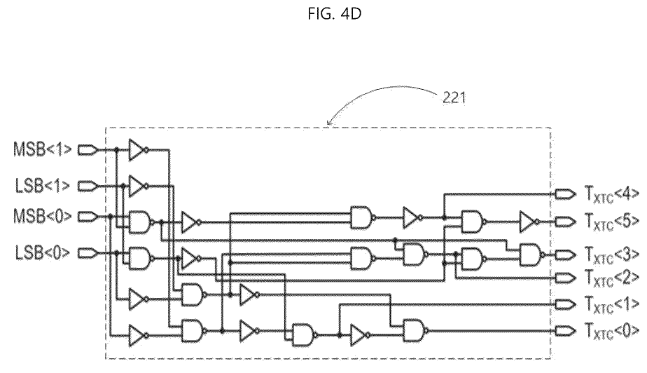

FIG. 4A illustrates a transmitting stage including a cancellation circuit of FIG. 1. FIG. 4B illustrates a table including an output of a cancellation circuit according to inputs of the second and third channels. FIG. 4C illustrates an example of a circuit diagram of a cancellation circuit of FIG. 1. FIG. 4D illustrates an example of a converter connected with a cancellation circuit according to the present disclosure.

Referring to FIGS. 4A to 4D together, the first channel 101 according to an embodiment may include the cancellation circuit 122 to cancel crosstalk.

In more detail, the first channel 101 may include a converter 221 that receives a second input signal of the second channel 102 and a third input signal of the third channel 103. In addition, the first channel 101 may include the cancellation circuit 122 that outputs a compensation signal 502 to cancel crosstalk generated in the first channel 101 due to the second input signal and the third input signal.

In this case, referring to FIG. 4A, the cancellation circuit 122 according to an embodiment may be referred to as a single auxiliary amplifier, but is not limited thereto.

In addition, referring to FIG. 4D, the converter 221 may be formed of a plurality of logic gates. For example, the converter 221 may be formed of at least one NAND gate and at least one inverter, but a circuit configuration of the converter 221 is not limited to the above-described example.

First, the cancellation circuit 122 may convert the second input signal and the third input signal into a preset number of bits using the converter 221. In more detail, the converter 221 may convert the MSB input and the LSB input included in the input signal of each channel into a preset number of bits by applying different weights to the MSB input and the LSB input.

For example, the converter 221 may apply a weight of “2” to each MSB input included in the second input signal and the third input signal, and may apply a weight of “1” to each LSB input included in the second input signal and the third input signal. Through this, the converter 221 may generate a 6-bit signal from the second input signal and the third input signal. In this case, the 6-bit signal may be understood as including a component 501A of the second input signal and a component 501B of the third input signal.

In addition, in this case, the converter 221 may be understood as a B2T 4-to-6 converter (binary to thermometer 4-to-6 converter) that converts a 4-bit binary weight signal into a 6-bit thermometer weight signal. However, the number of bits of the input signal or the output signal of the converter 221 is not limited thereto.

Subsequently, the cancellation circuit 122 may determine a component of crosstalk occurring in the first channel 101 based on the component 501A of the second input signal and the component 501B of the third input signal obtained through the converter 221.

For example, referring to FIG. 4A, the cancellation circuit 122 may determine a component of crosstalk occurring in the first channel 101 as “+6” in response to the component 501A of the second input signal and the component 501B of the third input signal being “+3”, respectively.

Referring to FIG. 4B, the cancellation circuit 122 may determine a component of crosstalk occurring in the first channel 101 as “111111” in response to the component 501A of the second input signal and the component 501B of the third input signal being “11”, respectively.

Furthermore, the cancellation circuit 122 may output the compensation signal 502 that includes an opposite component to the determined crosstalk component.

For example, referring to FIG. 4A, when the crosstalk component is determined as “+6,” the cancellation circuit 122 may output the compensation signal 502 having a component of “−6”.

To this end, referring to FIG. 4C, the cancellation circuit 122 may include a plurality of transistors. According to an embodiment, the cancellation circuit 122 may activate (or turn on) at least some of the plurality of transistors based on the determined crosstalk component.

In more detail, the cancellation circuit 122 may short-circuit the output to the power source by activating a PMOS when the crosstalk bit is “0”. In addition, when the crosstalk bit is “1”, the cancellation circuit 122 may short-circuit the output to ground by activating an NMOS.

For example, when the crosstalk bit is determined as “001111”, the cancellation circuit 122 may activate a first NMOS 551b, a second NMOS 552b, a third NMOS 553b, a fourth NMOS 554b, a fifth PMOS 555a, and a sixth PMOS 556a.

Through this, the cancellation circuit 122 may output the compensation signal 502 having a component of “110000”.

Furthermore, the cancellation circuit 122 may insert the generated compensation signal 502 into the PAM-4 signal output from the driver 121. Accordingly, the transmitting stage of the PAM-4 transceiver 10 may transmit a transmission signal in which the compensation signal 502 is combined with the PAM-4 signal generated by the driver 121 to the receiving stage.

According to another embodiment, the cancellation circuit 122 may not output the compensation signal 502 when it is determined that crosstalk does not occur as signal components (e.g., 501A, 501B) of adjacent channels are canceled out.

For example, when the component 501A of the second input signal has a component of “+3” and the component 501B of the third input signal has a component of “−3”, the cancellation circuit 122 may determine that crosstalk does not occur as the two components are canceled out. In this case, the cancellation circuit 122 may not generate the compensation signal 502.

Through this, the PAM-4 transceiver 10 according to the present disclosure may save power consumption required for the operation of the cancellation circuit 122.

As previously observed, the PAM-4 transceiver 10 according to an embodiment of the present disclosure may use the cancellation circuit 122 to generate the compensation signal corresponding to crosstalk occurring due to signals of adjacent channels. Furthermore, the PAM-4 transceiver 10 may cancel crosstalk of the PAM-4 signal by combining (or inserting) the generated compensation signal into the transmitted and received PAM-4 signals.

Through this, the PAM-4 transceiver 10 according to an embodiment of the present disclosure may minimize interference due to coupling between adjacent channels and may improve the integrity of transmitted and received signals.

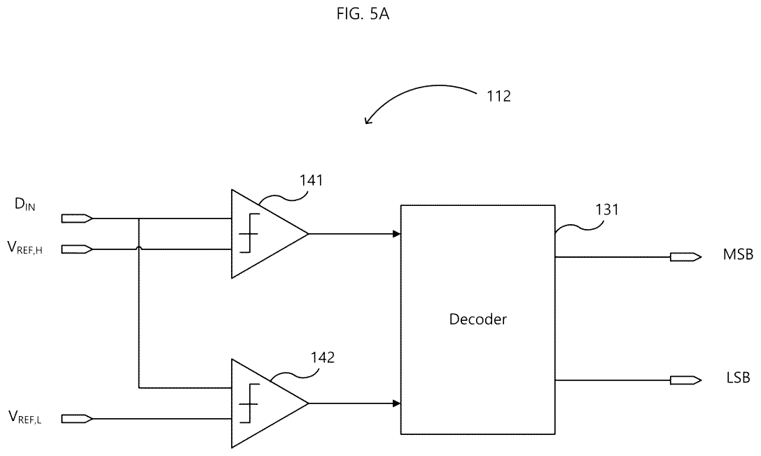

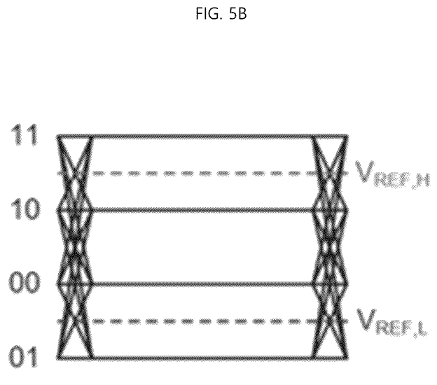

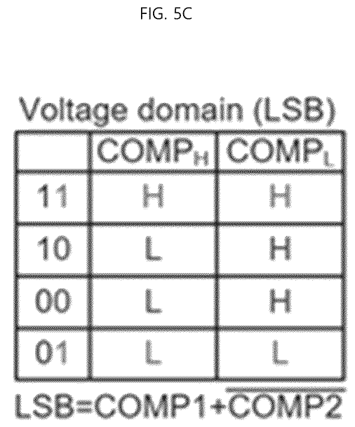

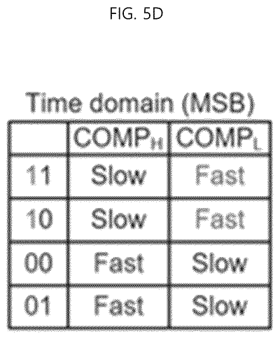

FIG. 5A illustrates a receiving stage including a first comparator, a second comparator, and a decoder according to the present disclosure. FIG. 5B illustrates a PAM-4 signal and a reference voltage according to the present disclosure. FIG. 5C illustrates logic by which a decoder of FIG. 5A determines an LSB output based on a comparison result of a first comparator and a second comparator. FIG. 5D illustrates logic by which a decoder of FIG. 5A determines an MSB output based on a comparison result of a first comparator and a second comparator.

Referring to FIGS. 5A to 5D together, the receiving stage 112 of the PAM-4 transceiver 10 according to an embodiment may use the first comparator 141, the second comparator 142, and the decoder 131 to output an output signal corresponding to the input signal from a received signal D_{IN}.

Referring to FIG. 5A, the receiving stage 112 according to an embodiment may include the first comparator 141 that compares the received signal D_{IN} with a first reference voltage V_{REF, H}, and the second comparator 142 that compares the received signal D_{IN} with a second reference voltage V_{REF, L}.

In this case, referring to FIG. 5B, the first reference voltage V_{REF, H} may be set to a voltage between a “11” level and a “10” level of the PAM-4 signal D_{IN} composing of four voltage levels 11, 10, 00, and 01. In addition, the second reference voltage V_{REF, L} may be set to a voltage between a “00” level and a “01” level of the PAM-4 signal D_{IN}.

In this case, data of “11” “10” “00” “01” may be assigned to each of the four voltage levels through data encoding.

In addition, the receiving stage 112 may include the decoder 131 connected to the first comparator 141 and the second comparator 142.

According to an embodiment, the decoder 131 may generate an output signal including an MSB output and an LSB output based on a first comparison result of the first comparator 141 and a second comparison result of the second comparator 142.

In more detail, the decoder 131 may determine the MSB output and the LSB output in different domains, respectively, based on the first comparison result and the second comparison result.

For example, the decoder 131 may determine the LSB output based on whether the first comparison result is the same as the second comparison result. In addition, the decoder 131 may determine the MSB output based on the size of the voltage margin included in each of the first and second comparison results.

According to an embodiment, the decoder 131 may determine the LSB output based on whether the first comparison result is the same as the second comparison result in the voltage domain.

For example, when the received signal has a level of “11”, the voltage level of the corresponding signal has a higher level than the first and second reference voltages, so the first and second comparison results may be output as “H”. Therefore, since the first comparison result and the second comparison result have the same value as “H”, the decoder 131 may determine the LSB output as “1”.

For another example, when the received signal has a level of “10”, the voltage level of the corresponding signal is less than the first reference voltage and higher than the second reference voltage, so the first comparison result may be output as “L” and the second comparison result may be output as “H”. Therefore, since the first comparison result and the second comparison result have different values, the decoder 131 may determine the LSB output as “0”.

In addition, the decoder 131 may determine the MSB output in the time domain based on the size of the first voltage margin included in the first comparison result and the size of the second voltage margin included in the second comparison result. In this case, the first voltage margin may be understood as the difference (or margin) between the voltage level of the received signal and the first reference voltage. In addition, the second voltage margin may be understood as the difference between the voltage level of the received signal and the second reference voltage.

For example, when the received signal has a voltage level of “11”, since the first voltage margin between the voltage level of the corresponding signal and the first reference voltage is less than the second voltage margin between the voltage level of the corresponding signal and the second reference voltage, the decoder 131 may determine the MSB output as “1”.

For another example, when the received signal has a level of “01” level, since the first voltage margin between the voltage level of the corresponding signal and the first reference voltage is greater than the second voltage margin between the voltage level of the corresponding signal and the second reference voltage, the decoder 131 may determine the MSB output as “0”.

To this end, the decoder 131 may further include a time comparator circuit to compare the first voltage margin with the second voltage margin in the time domain. In this case, the time comparator circuit is refreshed by a clock (CK) signal and may detect a first signal that occurs after the refresh.

As previously observed, the PAM-4 transceiver 10 (or the decoder 131) according to an embodiment of the present disclosure may use the first comparator 141, the second comparator 142, the first reference voltage, and the second reference voltage to decode signals on different domains.

Through this, the PAM-4 transceiver 10 may reduce the comparators required for decoding the PAM-4 signal and requirements of reference voltages.

According to an embodiment of the present disclosure, the PAM-4 transceiver may increase the bandwidth of the output signal by transmitting and receiving the PAM-4 signal through capacitive-driven channels.

In addition, according to an embodiment of the present disclosure, the PAM-4 transceiver may improve the integrity of transmitted and received signals by inserting a compensation signal based on the input signals of adjacent channels into the transmitted signal.

As described above, the present disclosure has been described with reference to the illustrative drawings, but the present disclosure is not limited to the embodiments and drawings disclosed herein, and it will be obvious that various modifications may be made by those skilled in the art within the scope of the technical sprit of the present disclosure. In addition, although the operational effects according to the configuration of the present disclosure are not explicitly described and described while describing the embodiments of the present disclosure above, it will be obvious that the predictable effects by the configuration should also be recognized.

What is claimed is:

1. A PAM-4 transceiver comprising:
a first channel configured to transmit and receive a PAM-4 signal generated based on a first input signal through a coupling capacitor disposed at a transmitting stage; and
a second channel and a third channel disposed adjacent to the first channel, and
wherein the first channel includes:
a converter configured to receive a second input signal of the second channel and a third input signal of the third channel; and
a cancellation circuit connected to the converter and configured to cancel a crosstalk occurring in the first channel due to the second input signal and the third input signal, and
wherein the cancellation circuit outputs a compensation signal corresponding to the crosstalk based on the second input signal and the third input signal.

2. The PAM-4 transceiver of claim 1, wherein the converter determines a component of the crosstalk occurring in the first channel based on the second input signal and the third input signal, and
wherein the cancellation circuit outputs the compensation signal including an opposite component to the determined component of the crosstalk.

3. The PAM-4 transceiver of claim 2, wherein the cancellation circuit includes a plurality of transistors, and
outputs the compensation signal including the opposite component by activating at least some of the plurality of transistors based on the component of the crosstalk.

4. The PAM-4 transceiver of claim 1, wherein the first channel includes a driver configured to generate the PAM-4 signal having four signal levels from the first input signal, and
transmit a signal obtained by combining the compensation signal with the PAM-4 signal.

5. The PAM-4 transceiver of claim 4, wherein the driver is configured to:
generate three bit outputs with preset weights based on an MSB input and an LSB input included in the first input signal, and
generate the PAM-4 signal having the four signal levels using the three bit outputs.

6. The PAM-4 transceiver of claim 4, wherein the first channel further includes a power source connected to the driver, and
wherein, when a signal with a preset pattern occurs among the PAM-4 signal, the first channel applies an input voltage to a path through which the PAM-4 signal is transmitted using the power source.

7. The PAM-4 transceiver of claim 1, wherein a receiving stage of the first channel includes a first comparator, a second comparator, and a decoder,
the first comparator compares a received signal received from the transmitting stage with a first reference voltage and outputs a first comparison result,
the second comparator compares the received signal with a second reference voltage and outputs a second comparison result, and
the decoder generates an LSB output based on whether the first comparison result is the same as the second comparison result.

8. The PAM-4 transceiver of claim 7, wherein the first comparison result includes a first voltage margin between the received signal and the first reference voltage,
the second comparison result includes a second voltage margin between the received signal and the second reference voltage, and
the decoder generates an MSB output by comparing sizes of the first voltage margin and the second voltage margin.

9. A transceiver comprising a transmitting stage and a receiving stage connected through a high-density channel, and
wherein the transmitting stage includes:
a driver including a coupling capacitor and configured to generate a PAM-4 signal having 4 levels from a first input signal; and
a cancellation circuit configured to receive a second input signal from at least one adjacent channel and to output a compensation signal corresponding to a crosstalk occurring due to the second input signal, and
wherein the transmitting stage is configured to output a transmission signal obtained by combining the compensation signal with the PAM-4 signal, and
wherein the receiving stage is configured to:
include a first comparator, a second comparator, and a decoder connected to the first comparator and the second comparator;
compare the transmission signal with a first reference voltage and a second reference voltage using the first comparator and the second comparator; and
generate an output signal corresponding to the first input signal through the decoder based on the comparison result.

10. The transceiver of claim 9, wherein the driver is configured to:
generate three bit outputs based on an MSB input and an LSB input, which are included in the first input signal, and
generate the PAM-4 signal with the 4 levels using the three bit outputs.

11. The transceiver of claim 9, wherein the cancellation circuit is configured to:
determine a component of the crosstalk based on the second input signal, and
output the compensation signal including an opposite component of the component of the crosstalk.

12. The transceiver of claim 9, wherein the decoder is configured to:
generate an LSB output based on whether a first comparison result of the first comparator is the same as a second comparison result of the second comparator, and
generate an MSB output by comparing a size of a first voltage margin included in the first comparison result with a size of a second voltage margin included in the second comparison result.
